(19) United States
(12) Patent Application Publication
(10) Pub. No.: US 2023/0349511 A1
(43) Pub. Date: Nov. 2, 2023

(54) LUBRICATING OIL STATION FOR A PLANT AND METHOD FOR OPERATING A LUBRICATING OIL STATION

(71) Applicant: Siemens Energy Global GmbH & Co. KG, Munich, Bayern (DE)

(72) Inventors: Peter Rupprecht, Wesel (DE); Andre Fischedick, Willich (DE)

(73) Assignee: Siemens Energy Global GmbH & Co. KG, Munich, Bayern (DE)

(21) Appl. No.: 18/025,902

(22) PCT Filed: Sep. 3, 2021
(86) PCT No.: PCT/EP2021/074352

§ 371 Date: Mar. 12, 2023

(30) Foreign Application Priority Data
Sep. 29, 2020 (CN) 202022199789.1

(51) Int. Cl. F16N 29/02; F16N 7/38

(52) U.S. Cl. CPC F16N 7/38; F16N 29/02; F16N 2013/063; F16N 2210/14; F16N 2270/56

(57) ABSTRACT

A lubricating oil station having a pump that pumps oil into a bearing shell, wherein the quantity of oil is controlled by designing the pump with control of the rotational speed, the rotational speed being controlled by a control unit.

### CROSS REFERENCE TO RELATED APPLICATIONS

This application is the US National Stage of International Application No. PCT/EP2021/074352 filed 03 Sep. 2021, and claims the benefit thereof. The International Application claims the benefit of Chinese Application No. CN 202022199789.1 filed 29 Sep. 2020. All of the applications are incorporated by reference herein in their entirety.

### FIELD OF INVENTION

The invention relates to a lubricating oil station for supplying a unit with oil, in particular lubricating oil, comprising an oil reservoir, which can be filled with oil, a pump, which is fluidically connected to the oil reservoir, wherein the pump is coupled to a drive, wherein the drive is designed in such a way that the speed of the pump is variable, furthermore an arrangement which can be supplied with oil from the oil reservoir via the pump, furthermore a line, which establishes a fluidic connection between the pump and the unit.

### BACKGROUND OF INVENTION

A lubricating oil station is used, amongst other things, to supply an arrangement, for example a slide bearing of a continuous-flow machine, for example of a compressor or a steam turbine, with oil. In a slide bearing, the slideably mounted rotor rotates on a lubricating film in a bearing shell. However, with a slide bearing, power losses may arise, which are caused by friction. The friction losses here occur through the radial and axial bearing. The lubricating film comprises a lubricating medium, wherein oil is generally used. The oil is fed continuously to the slide bearing via oil pumps. The oil is fed out of the slide bearing via outlet channels. The oil feed is designed in such a way that the slide bearing is fundamentally oversupplied with oil so that the friction partners, the rotor shell and bearing shell, do not rub directly against one another. The oil is oversupplied due to the fact that inadequate lubricating conditions of the slide bearing may only be simulated approximately; in particular the influence of inadequate lubrication on the dynamic bearing properties, for example in the event of shaft vibrations. The oil is furthermore also oversupplied due to the fact that the rotors are loaded under different load conditions.

Slide bearings are used, for example, to mount rotors of steam turbines, gas turbines or compressors and generators, for example. In a slide bearing, the slideably mounted rotor rotates on a lubricating film in a bearing shell. However, with a slide bearing, power losses may arise, which are caused by friction. The friction losses here occur through the radial and axial bearing. The lubricating film comprises a lubricating medium, wherein oil is generally used. The oil is fed continuously to the slide bearing via oil pumps. The oil is fed out of the slide bearing via outlet channels. The oil feed is designed in such a way that the slide bearing is fundamentally oversupplied with oil so that the friction partners, the rotor shell and bearing shell, do not rub directly against one another. The oil is oversupplied due to the fact that inadequate lubricating conditions of the slide bearing may only be simulated approximately; in particular the influence of inadequate lubrication on the dynamic bearing properties, for example in the event of shaft vibrations. The oil is furthermore also oversupplied due to the fact that the rotors are loaded under different load conditions.

An inflow of lubricating medium is generally provided for each slide bearing. According to the prior art, the oil pump is set to a fixed speed here, which is therefore not variable. However, the quantity of oil is regulated. This takes place through a bypass line, which conducts a portion of the oil around the oil pump. An adjustable valve is arranged in this bypass line and is able to regulate the quantity and the pressure in the oil line. A control unit is therefore provided, which adjusts the position of the valve. This control unit is coupled to input signals, for example the pressure and the flow rate. The control unit is coupled to the valve via output signals. The oil requirement is therefore optimally set via the position of the valve, wherein the valve is in turn activated via the control unit.

There is a requirement for such lubricating oil stations to have a simpler and more cost-effective design.

### SUMMARY OF INVENTION

An object of the invention is to specify a simplified lubricating oil station.

This object is achieved by a lubricating oil station for supplying a unit with oil, in particular lubricating oil, comprising an oil reservoir, which can be filled with oil, a pump, which is fluidically connected to the oil reservoir, wherein the pump is coupled to a drive, wherein the drive is designed in such a way that the speed of the pump is variable, furthermore an arrangement which can be supplied with oil from the oil reservoir via the pump, furthermore a line, which establishes a fluidic connection between the pump and the unit, with a control unit, wherein the control unit is designed in such a way that it is connected to at least one input signal and the control unit generates an output signal with which the speed of the pump is regulated.

An essential aspect of the invention is to design a lubricating oil station without a bypass line. In this case, the invention is based on the idea of using a variable-speed pump, and not the bypass valve, to adjust the oil to the necessary quantity and the necessary pressure. The variable-speed pump is connected to a control unit here, with which the pump is actuated in such a way that the quantity of oil and the pressure in the oil is optimized and configured as needed.

Advantageous developments are specified in the dependent claims.

Therefore, in a first advantageous development, the pump is designed as a positive displacement pump. In positive displacement pumps, the medium is conveyed in enclosed volumes and a backflow is prevented by valves or flaps, other media or the design of the pump, due to gravity. A positive displacement pump is optimally used in a lubricating oil station.

In a further advantageous development, the output signal is connected to an input of a frequency converter, wherein the output of the frequency converter is connected to the pump so that the speed can be altered via the frequency converter. A frequency converter is a converter which converts an AC voltage to an AC voltage whereof the frequency and amplitude can be altered to directly power electric machines such as three-phase motors. The use of a frequency converter offers many advantages. The speed of the pump can therefore be easily set via the frequency converter, which controls a three-phase motor.

In a further advantageous development, the pressure in the line is used as an input signal. In addition to the pressure in the line, the quantity of oil in the line may also be used.

Precise regulation for the oil requirement of the arrangement is ensured through the selection of these input signals. The quantity and, if necessary, the pressure may be set comparatively precisely here.

In a further advantageous development, the arrangement is designed as a bearing, in particular a slide bearing. The use of a speed-controlled pump is particularly optimal when the lubricating oil station is used with a bearing, in particular a slide bearing.

The object is achieved by a method for operating a lubricating oil station having the above design.

The above-described properties, features and advantages of this invention, as well as the manner in which they are achieved, will become clearer and more easily understood in conjunction with the description below of the exemplary embodiments, which are explained in more detail in conjunction with the drawings.

Identical components or components with an identical function are denoted by identical reference signs here. Exemplary embodiments of the invention are described below with the aid of the drawing. This is not intended to be an authoritative representation of the exemplary embodiments; instead, the drawing, where useful for explanatory purposes, is presented in a schematized and/or slightly distorted form. In respect of additions to the teaching shown directly in the drawing, reference is made to the relevant prior art.

### BRIEF DESCRIPTION OF THE DRAWINGS

In the drawing:

FIG. 1 shows a schematic illustration of a lubricating oil station according to the prior art;

FIG. 2 shows a schematic illustration of a lubricating oil station according to the invention.

### DETAILED DESCRIPTION OF INVENTION

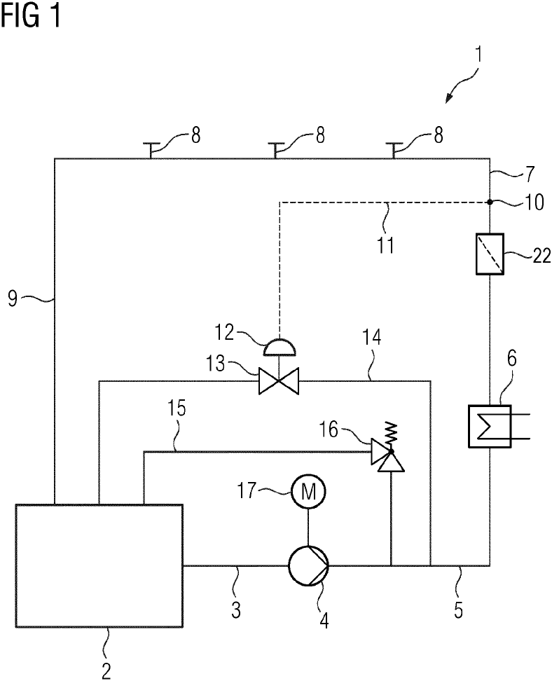

FIG. 1 shows a schematic illustration of a lubricating oil station 1 according to the prior art. The lubricating oil station 1 comprises an oil reservoir 2, which can be filled with oil. The oil reservoir 2 is fluidically connected to a pump 4 via a first line 3. The pump 4 is advantageously designed as a positive displacement pump.

A second line 5, which establishes a fluidic connection between the pump 4 and an intercooler 6, is arranged downstream of the pump 4. The oil flowing out of the oil reservoir 2 is cooled in this intercooler 6. The oil flowing out of the intercooler 6 then flows to an arrangement (not illustrated in more detail) via a third line 7. This arrangement may be designed as a slide bearing. The slide bearing may in turn be a slide bearing for a continuous-flow machine, for example of a steam turbine or a compressor. The slide bearing is fluidically connected to the third line 7 via supply nozzles 8. The flow nozzles 8 are only shown schematically in the figures.

The oil makes its way back to the oil reservoir 2 from the arrangement via a return line (not illustrated in more detail). This takes place via a fourth line 9.

A measuring sensor 10 is arranged in the third line 7. The measuring sensor 10 measures the pressure of the oil in the third line 7 and the flow rate of the oil in the third line 7. Further measurements of physical parameters, for example the temperature, are possible.

An oil filter 22 is likewise arranged in the third line 7. Based on the contamination, which alters over time, the oil filter 22 acts as a “disturbance variable” for regulation purposes.

The pressure and the flow rate of the oil are transmitted to a first control unit 12 as input signals 11. The first control unit 12 is connected to a valve 13. The valve 13 is arranged in a bypass line 14. The bypass line 14 fluidically connects the second line 5 to the fourth line 9. As can be seen in FIG. 1, the pump 4 is fluidically bypassed, as it were, by the bypass line 14. This means that the quantity and the pressure of the oil in the third line 7 may be varied via the quantity and the pressure of the oil in the bypass line 14. The position of the valve 13 here is set via the first control unit 12. The quantity of oil needed by the arrangement is therefore set via the position of the valve 13. The pump 4 may thus be operated at a stable speed.

An overpressure valve 16 is arranged across a further second bypass line 15 around the pump 4. In the event of a fault, it may occur that the pressure in the second line 5 is possibly too high, for example, and, to prevent damage to the pump 4, the overpressure valve 16 opens to relieve the pressure in the second line 5.

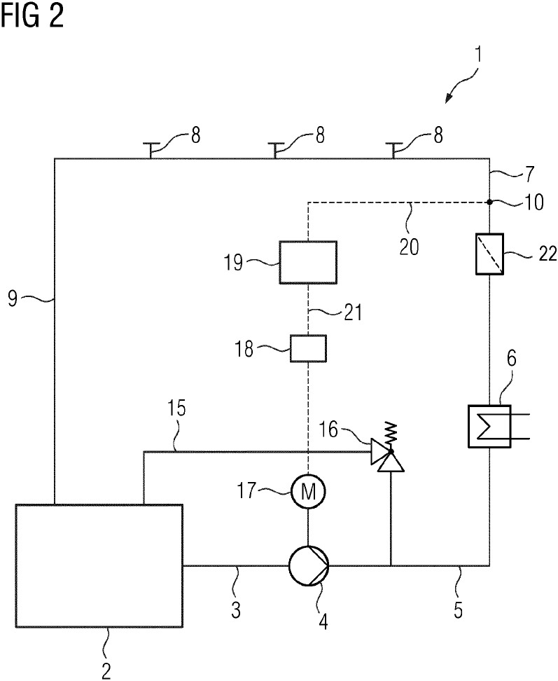

FIG. 2 shows a schematic illustration of a lubricating oil station 1 according to the invention.

The difference between the lubricating oil station 1 according to FIG. 1 and the lubricating oil station 1 according to FIG. 2 consists, amongst other things, in that the first bypass line 14 may be omitted. According to the invention, the quantity and the pressure of the oil in the third line 7 is regulated via the speed of the pump 4. To this end, the pump 4 is connected to a drive 17, wherein the drive is designed as a motor. The speed of the motor is coupled to the speed of the pump 4. The speed of the pump may thus be altered with the speed of the motor.

The motor is coupled to a frequency converter 18. The speed of the motor is altered by the frequency converter 18.

The lubricating oil station furthermore comprises a control unit 19. This control unit 19 is connected, on the one hand, to input signals 20. These input signals 20 identify the quantity and the pressure of the oil in the third line 7, for example. The control unit 19 is moreover connected to output signals 21. The frequency converter 18 is activated by output signals 21. The control unit 19 is designed in such a way that, via the measured input signals 20, it generates output signals 21 adapted to the requirement of the arrangement, which result in an optimum speed of the pump 4. In other words: the pressure and quantity in the third line 7 is regulated via the speed of the pump 4, wherein the speed is regulated via the control unit 19.

The quantity of oil needed for the arrangement is therefore identified by the control unit and pumped to the arrangement at a regulated speed via the pump.

Although the invention has been illustrated and described in more precise detail using the exemplary embodiment, the invention is not restricted by the disclosed examples and other variations may be derived therefrom via a person skilled in the art without departing from the scope of protection of the invention.

1. A lubricating oil station for supplying an arrangement with oil, comprising:
an oil reservoir, which is fillable with oil,
a pump (4), which is fluidically connected to the oil reservoir, wherein the pump is coupled to a drive, wherein the drive is designed in such a way that a speed of the pump is variable,
an arrangement, which can be supplied with oil from the oil reservoir via the pump,
a line, which establishes a fluidic connection between the pump and the arrangement, and
a control unit, wherein the control unit is connected to at least one input signal and the control unit generates an output signal with which the speed of the pump is regulated.

2. The lubricating oil station as claimed in claim 1,
wherein the pump (4) is designed as a positive displacement pump.

3. The lubricating oil station as claimed in claim 1,
wherein the output signal is connected to an input of a frequency converter and an output of the frequency converter is connected to the pump (4) so that the speed can be altered via the frequency converter.

4. The lubricating oil station as claimed in claim 1,
wherein a pressure in the line is used as an input signal.

5. The lubricating oil station as claimed in claim 1,
wherein the arrangement is designed as a bearing.

6. A method for operating a lubricating oil station, which is designed as claimed in claim 1, comprising:
identifying a quantity of oil needed for the arrangement by the control unit and supplied to the arrangement at a regulated speed via the pump (4).

7. The method as claimed in claim 6, further comprising:
regulating a pressure of the oil via the speed of the pump (4).

8. The lubricating oil station as claimed in claim 1,
wherein the oil comprises lubricating oil.
